(19) United States
(12) Patent Application Publication
(10) Pub. No.: US 2004/0260928 A1
(43) Pub. Date: Dec. 23, 2004

(54) Wim manufacturer certificate

(76) Inventor: Olli Immonen, Helsinki (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/891,116

(22) Filed: Jul. 15, 2004

Related U.S. Application Data
(63) Continuation of application No. 09/597,982, filed on Jun. 19, 2000.

(30) Foreign Application Priority Data
Jun. 18, 1999 (GB) 9914262.2

(51) Int. Cl. H04L 9/00

(52) U.S. Cl. 713/175

(57) ABSTRACT

Apparatus and a method for enhancing the security of a wireless application protocol identity module (WIM) is disclosed in which a manufacturer certificate is stored on the module which permits a third party such as a Certification Authority to have confidence in the security precautions taken during the creation and storage of a public-private key pair on the module.

### CROSS REFERENCE TO RELATED APPLICATION

The present application is a continuation of application Ser. No. 09/597,982, filed Jun. 19, 2000, the contents of which are incorporated herein by reference.

### BACKGROUND OF THE INVENTION

The present invention relates to a security method using asymmetric key cryptography, particularly although not exclusively for use with a wireless application protocol identity module.

Asymmetric or public-key cryptography, as is now well known, Utilizes a private key to which a user only has access and a public key, which may be published or distributed on request for the use of those wishing to communicate with the user. A third party wishing to communicate with the user will first obtain a certificate bearing the user's public key, which may be obtained from a certification authority (CA). The third party is then able to encrypt a message using the user's public key for subsequent decryption by the user using his private key. The approach means that a pair of users can communicate using their own key pairs without ever having to exchange their private keys. However, in practice the computational effort required to encrypt data is such that it is rarely suitable for large messages.

However, the technique is suitable for authentication, non-repudiation and integrity services. As such, the technique is particularly suited and has been adopted for use in the Wireless Application Protocol (WAP), for example. WAP is an industry-wide specification for developing applications that operate over wireless communication networks. For reference purposes, the WAP specifications are published by the Wireless Application Protocol Forum Ltd. and presently available at http://www.wapforum.org.

The requirement for authentication, non-repudiation and integrity services is one which is particularly relevant to the needs of e-commerce and in particular Financial Service Providers (FSPs) e.g. banks. Traditionally, goods and services have been purchased using physical objects whether coinage, notes, cheques, credit and charge cards and the like. This has provided the vendor with the opportunity to assess whether the payment is genuine. For example, In the case of notes this may take the form of the feel of the paper whilst a visual inspection of the hologram and signature on a credit card may suffice. In the case of telephone payment using a credit card, or indeed a store purchase, the assessment may include checking the card number against a stop list. However, with the advent of e-commerce and in particular the opportunity for cashless transactions based on data held in an individual communication terminal such as a mobile telephone, there exists the problem of assessing a transaction where the parties are unable to carry out physical checks. Thus, it has been proposed to utilize the technique set out above to assist in such transactions. To provide security for the private keys used to provide WAP client authentication, electronic signatures and the like, it has been found necessary to utilize a tamper-resistant device. This device is known as a WAP identity module (WIM). The WIM is used especially to store and process information needed for user identification and authentication. Typically, a WIM might be implemented as a smart card. In the case of a mobile telephone, the WIM could form part of the Subscriber Identity Module (SIM) card or perhaps an external smart card.

Nevertheless, there remains a significant further problem of security, namely forgery and fraud in relation to the manufacture of the WIM itself. It is an aim of the present invention to guard against forgery and fraud in relation to the manufacture of a WIM. It is a further aim of the present invention to provide a method of establishing confidence in the security of a WIM manufactured according to a range of techniques.

### SUMMARY OF THE INVENTION

Thus, according to a first aspect of the present invention, there is provided a tamper evident wireless application protocol identity module (WIM) including stored thereon a public-private key pair and a manufacturer certificate, wherein the manufacturer certificate contains a set of fields holding data relating to said key pair, the certificate being signed using a further private key.

Preferably the manufacturer certificate is signed using the manufacturer's private key although in circumstances where the module is distributed to a user prior to the creation of a manufacturer certificate, it is necessary to store an initial management certificate and associated signature using an initial management private key in order to provide means for validating the signature applied to the manufacturer certificate

According to another aspect of the present invention, there is provided a method of manufacturing a tamper-evident wireless application protocolidentity module (WIM) including the steps of storing a public-private key pair on said module together with a manufacturer certificate signed using a further private key.

Again, the manufacturer certificate is preferably signed using the manufacturer's private key although in circumstances where the module is distributed to a user prior to the creation of a manufacturer certificate, it will be necessary to include the further step of storing an initial management certificate and associated signature using an initial management private key in order to provide means for validating the signature applied to the manufacturer certificate.

In accordance with a further aspect of the present invention, there is provided a method of validating a tamper-evident wireless application protocol identity module (WIM) on which is stored at least one public-private key pair together with a manufacturer certificate signed using a further private key, the method including the step of querying a public directory to obtain a public key certificate with which to verify the signature generated by the further private key.

In accordance with a still further aspect of the invention, there is provided a method of validating the identity of a communication terminal for conducting transactions on a network comprising establishing the identity of a user of the terminal connected to the network, interrogating the terminal to obtain a public key of a public-private key pair stored on the terminal, confirming the authenticity of a certificate signed by the module manufacturer supporting the public key and subsequently issuing a further certificate for the public key which certificate is available to support transactions with the terminal over the network.

Preferably, the network service provider may carry out the authentication of the manufacturer certificate. Advantageously, at least the private key is stored on a tamperproof module which may be integrated with a Subscriber Identity Module (SIM) located in the terminal.

In accordance with yet another aspect of the invention, there is provided a communications device having stored thereon a plurality of certificates supporting security operations including authentication and non-repudiation, and further including a manufacturer certificate stored on a tamper evident module, wherein the manufacturer certificate contains a set of fields holding data relating to a public-private key pair for application layer security, at least the private key being stored on said module, the manufacturer certificate being signed using a further private key.

While, in accordance with a still further aspect of the invention, there is provided a method of satisfying an identity module issuer of the provenance of an identity module for use in transactions on a network comprises the issuer approving a manufacturing process of the module manufacturer and having the manufacturer store a manufacturer certificate signed securely by the manufacturer on a module produced in accordance with the approved process, wherein on connection to the network of a terminal containing a module, the signature is verified to determine whether it is the manufacturer's.

### BRIEF DESCRIPTION OF THE DRAWINGS

In order to aid in understanding the present invention, a number of embodiments thereof will now be described by way of example and with reference to the accompanying drawings, in which:

FIG. 1a is a table illustrating the contents of a manufacturer certificate generated in accordance with the method of the present invention;

FIG. 1b is a table illustrating the key usage indicators forming part of the contents of the manufacturer certificate of FIG. 1a;

FIG. 2 is a flowchart of the steps involved in creating a WIM containing the manufacturer certificate of FIG. 1 according to a first embodiment of the invention;

FIG. 3 is a flowchart of the steps involved in creating a WIM containing the manufacturer certificate of FIG. 1 according to a second embodiment of the invention; and

FIG. 4 is a flowchart of the steps involved in creating a WIM containing the manufacturer certificate of FIG. 1 according to a third embodiment of the invention.

### DETAILED DESCRIPTION OF THE INVENTION

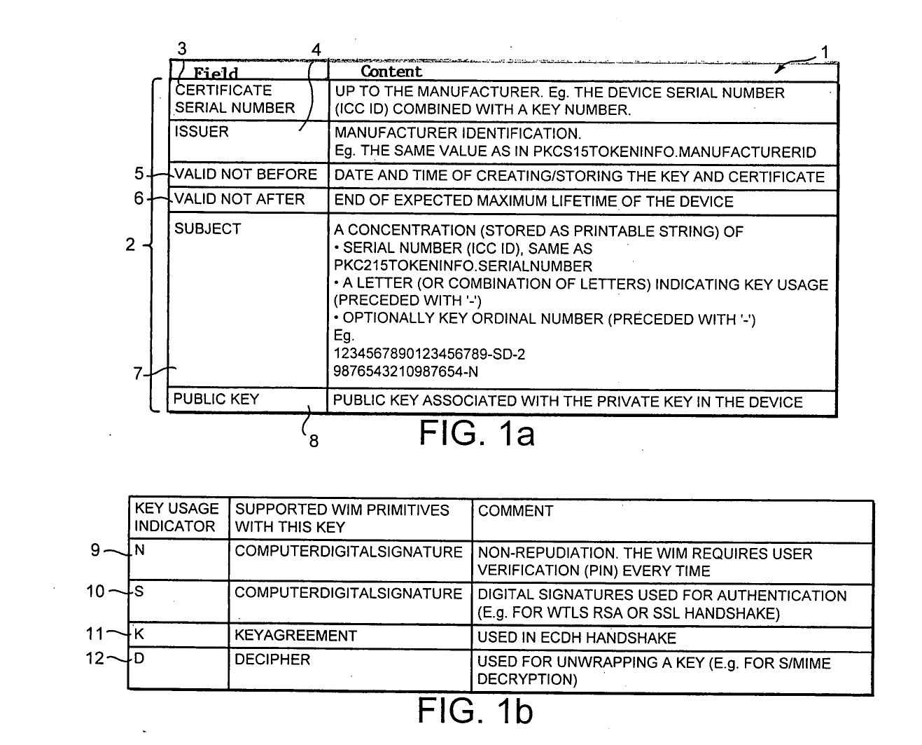

Referring firstly to FIG. 1a, the table shows the contents of a Wireless Application Protocol (WAP) Identity Module (WIM) manufacturer certificate 1 that is made up of a number of fields 2 which serve to identify the certificate 1 by reference to a serial number 3, the issuer or manufacturer 4, the first and last dates of the validity of the certificate 5,6, the nature of a private-public key pair covered by the certificate 7 and finally the public key itself 8.

In addition to storing the manufacturer certificate 1, the WIM may also store further certificates to be used, for example, in Secure Sockets Layer (SSL), and Transport Layer Security (TLS) client authentication and also for signing Secure Multi-purpose Internet Mail Extensions (S/MIME) messages. Furthermore, the WIM may store trusted Certification Authority (CA) certificates to enable verification of SSL, TLS servers and downloaded Java applications, for example. Such certificates may be stored by the WIM issuer or at a later time by the user. Where the available space on the WIM is insufficient or unavailable, rather than storing the further certificates on the module, they may be found by reference to a Universal Resource Location (URL) stored on the WIM.

FIG. 1b further defines the types of use to which a particular key pair may be put. Thus a key pair may be used in non-repudation 9 by which is meant the intrinsic feature of asymmetric cryptography of a user being unable to repudiate a previously authenticated message because, unlike private key systems, the user has the sole responsibility for protecting his private-key. A key pair may be used in the generation of a digital signature 10 which permits the authentication of documents and handshakes such as used in the wireless transport layer specification (WTLS) of WAP. A key pair may also be used in a key agreement 11 used to negotiate a secret, using a Diffie-Hellman scheme. Finally, a key pair can be used for decryption or unwrapping 12 of a key that is needed when an application installed in a communication terminal such as a mobile telephone handset receives a message key enciphered with a public key that corresponds to a private key in the WIM. The application sends the wrapped key to the WIM. The WIM deciphers it using the private key and returns the unwrapped key to the application so that it can then be used to decipher the attached message.

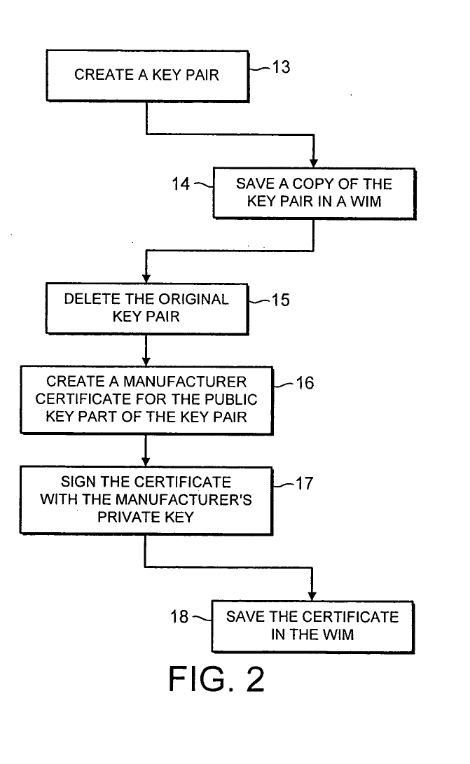

Referring now to FIG. 2, the flowchart sets out the steps according to which, in one embodiment of the invention, a WIM containing a manufacturer certificate 1 is created during the manufacture of a WIM prior to supply to a user. Firstly, a key pair is generated 13 outside the WIM and then saved 14 on a WIM, which may be integrated with a SIM card for use with a communications terminal such as a mobile telephone handset or as dedicated smartcard for use with such a terminal. Any record of the key pair existing outside the WIM must then be deleted 15. A manufacturer certificate containing the information described above is then created 16 externally of the WIM and signed 17 using the manufacturer's private key before being saved 18 onto the WIM. In a non-illustrated variant of the above method, rather than save the manufacturer certificate directly onto the WIM, a URL address pointing to the location of the certificate may be stored on the WIM thereby reducing the memory requirement of the WIM. It is important to recognize that in the above-described method there is no need for the WIM to support either the creation of a key pair or the creation of a manufacturer certificate.

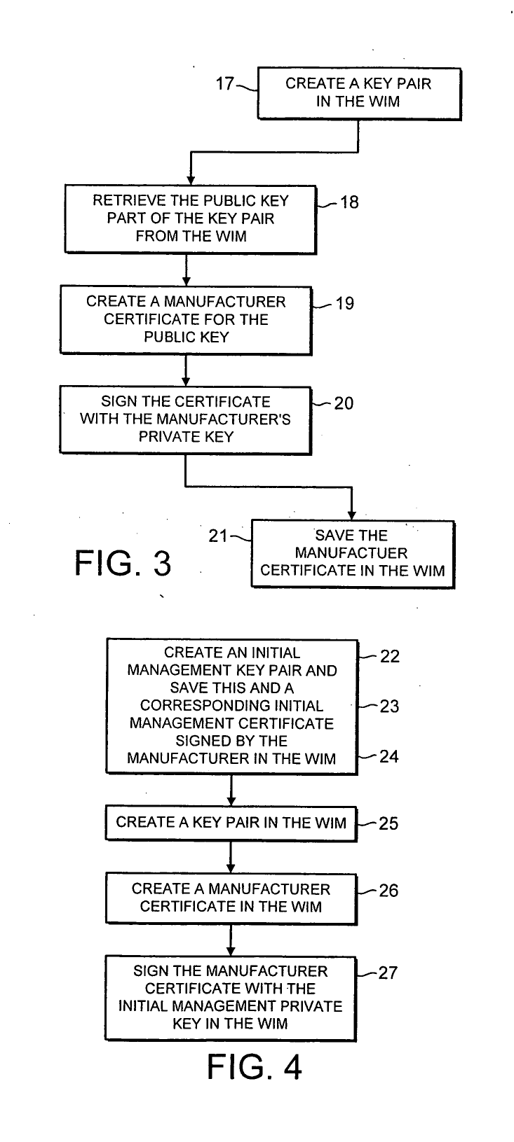

With reference to FIG. 3, the WIM manufacturer certificate is again created during the manufacture of a WIM before supply to a user. In this embodiment the WIM is provided with the functionality necessary to allow it to create a key pair internally 17 and then to permit the public key to be accessed 18 for the external generation 19 of a manufacturer certificate which is signed 20 using the manufacturer's private key. The manufacturer certificate (FIG. 1a) is then saved 21 onto the WIM although in a non-illustrated variant rather than save the manufacturer certificate directly onto the WIM, a URL address pointing to the location of the certificate may be stored on the WIM thereby reducing the memory requirement of the WIM. The fact that the key pair is generated within the WIM enhances the security of the method.

Finally, with respect to FIG. 4, this embodiment relates to the internal generation of a manufacturer certificate by a WIM once in the possession of a user. In this method, it is necessary first to generate 22 an initial management key pair outside the WIM and to save 23 this key pair, together with a corresponding initial management certificate signed 24 using the manufacturer's private key, on the WIM. The initial management key pair will provide only limited functionality inasmuch as it can only be used merely to certify a key pair generated by the WIM and thus is not capable of providing any of the functionality described above in relation to FIG. 1b. The WIM may then be distributed to a user whereupon the user issues an instruction or perhaps more usefully following receipt of an external instruction, such as an over the air Push (OTA-Push), the WIM creates 25 a key pair internally, following which the WIM generates 26 a corresponding manufacturer certificate signed 27 using the initial management private key. Clearly, for an external party to be satisfied of the legitimacy of a manufacturer certificate signed in this manner it will be necessary, in addition to the validation process set out below and applicable to all the embodiments set out herein, for that party also to validate the initial management certificate signed 24 using the manufacturer's private key as set out below.

Thus, following the manufacturing processes set out above, in each case it is necessary to validate the WIM before it can be utilized in commercial transactions by the communications device. Hence, the Certification Authority, namely the FSP that issues the WIM, i.e., on whose funds the user depends, must first be assured that the WIM has been produced by a manufacturer with whom has previously been agreed production processes which meet the requirements of the FSP to counter fraud, forgery and the like.

Most conveniently, the Certification Authority may delegate the task of validating a new user to a Registration Authority (RA) with which it has a trusted relationship. As the communication device in which the WIM is contained forms part of a network, the CA may delegate the network service provider as the RA. Thus to permit commercial transactions, the user will make a call to the RA during which the WIM public key 8 associated with the private key stored in the WIM is extracted and the identity of the user is confirmed by the RA in a known manner such as through an enquiry for personal data e.g., mother's maiden name or a single use password. The RA also authenticates the manufacturer signature on the certificate (FIG. 1a) containing the WIM public key 8. Accordingly, the RA obtains the manufacturer public key from a further certificate signed by a CA, in this case the FSP. Assuming the digital signature can be authenticated i.e. the CA has not revoked or suspended the Certificate covering the manufacturer public key, then the RA can issue a certificate for the WIM public key 8. This public-key certificate is then placed in a repository where it is available to the public for use in supporting commercial transactions.

Clearly, should the validation process fail then it will be known that the WIM is possibly a forgery. Furthermore, where, for whatever reason the CA has withdrawn support from the manufacturer it will be necessary only to inform the RA, through suspending or revoking the relevant certificate covering the manufacturer public key, to prevent validation of the WIM. A possible reason for the CA withdrawing support for a manufacturer could include a breakdown in the security protocols at the manufacturing location on which the approval of the manufacturer was originally based.

It will be clear from the above that all the steps carried out by the RA could be undertaken by the CA itself However, the fact that the network service provider has easy access to the communication device simplifies the process of validation. Also, through the usual network processes, for example the transfer of International Mobile Subscriber Identity (IMSI) and Temporary Mobile Subscriber Identity (TMSI) Codes, the network provides the benefit of revealing the nature of the device in which the WIM is installed. This information can prove useful to the FSP in determining the capability of the device to deal with different transactional services.

It will be recognized in relation to the foregoing that the existence of a manufacturer certificate on the WIM or an address at which it might be found can provide confidence to a Certification Authority (CA) that the key pair associated with that manufacturer certificate (FIG. 1a) has been securely placed on the WIM. Such confidence will, of course, stem from the fact that CA can identify the manufacturer of the WIM and, hopefully, be assured of the integrity of their key pair generation. Clearly, once the CA is confident of the integrity of the key pair it is in a position to issue a certificate certifying the identity of the WIM user for the subsequent use of those wishing to communicate with said user. As has been stated previously, in practice, the CA will verify the manufacturer certificate by firstly accessing a certificate containing the manufacturer's own public key. This public key can then be used to verify the manufacturer certificate itself. Furthermore, the manufacturer may well have a single CA certificate to certify all key pairs, or it may have a top CA for certification of intermediate CAs that certify actual key pairs. A top CA used by a particular manufacturer may itself be certified by a third party CA that also certifies the top CA of other manufacturers. Such a hierarchy of certification facilitates the secure distribution of the top CA certificates of different manufacturers.

What is claimed is:

1. A tamper evident wireless application protocol identity module (WIM) including stored thereon a public-private key pair and a manufacturer certificate, wherein the certificate contains a set of fields holding data relating to said key pair, the certificate being signed using a further private key.

2. A module as claimed in claim 1, wherein the public key is held with a field of said certificate.

3. A module as claimed in claim 1 further including a certification authority certificate.

4. A module as claimed in claim 1, wherein the at least one certificate is stored externally of said module at a remote location which is derivable from an address stored on said module.

5. A module as claimed in claim 1, wherein the further private key is the manufacturer's private key.

6. A module as claimed in claim 1, wherein the further private key is an initial management key, the module further having stored thereon an initial management certificate signed using the manufacturer's private key.

7. A method of manufacturing a tamper-evident wireless application protocol identity module (WIN) comprising the step of:
storing a public-private key pair on said module together with a manufacturer certificate signed using a further private key.

8. A method according to claim 7, wherein the key pair is created externally of said module.

9. A method according to claim 7, wherein the key pair is created internally of said module.

10. A method according to claim 9, wherein the manufacturer certificate is created externally of the module.

11. A method according to claim 10, wherein the module is accessed to obtain the public key to facilitate the external creation of the certificate.

12. A method as claimed in claim 7, wherein the further private key is the manufacturer's private key.

13. A method as claimed in Clam 9, further comprising the steps of:
storing an externally created initial management key pair and an initial management certificate signed using the manufacturer's private key on said module; and
storing an internally created manufacturer certificate on said module wherein the further private key is the initial management private key.

14. A method of validating a tamper-evident wireless application protocol identity module (WIM) on which is stored at least one public-private key pair together with a manufacturer certificate signed using a further private key, the method comprising the step of:
querying a public directory to obtain a public key certificate with which to verify the signature generated by the further private key.

15. A method of validating the identify of a communication terminal for conducting transactions on the network comprising the steps of:
establishing the identity of a user of the terminal connected to the network;
interrogating the terminal to obtain a public key of a public-private key pair stored on the terminal;
conforming the authenticity of a certificate signed by the module manufacturer supporting the public key; and
subsequently issuing a further certificate for the public key which certificate is available to support transactions with the terminal over the network.

16. A method as claimed in claim 15, wherein the network service provider carries out the authentication of the manufacturer certificate.

17. A communications device having stored thereon a plurality of certificates supporting security operations including authentication and non-repudiation, and further including a manufacturer certificate stored on a tamper evident module, wherein the manufacturer certificate contains a set of fields holding data relating to a public-private key pair for application layer security, at least the private key being stored on said module, the manufacturer certificate being signed using a further private key.

18. A device as claimed in claim 17, wherein at least one certificate supporting security operations is stored externally of said device at a remote location which is derivable from an address stored on said device.

19. A method of satisfying an identity module issuer of the provenance of an identify module for use in transactions on a network comprising the steps of:
approving, by the issuer, a manufacturing process of the module manufacturer;
storing, by the manufacturers a manufacturer certificate signed securely by the manufacturer on a module produced in accordance with the approved process; and
upon connection to the network of a terminal containing a module, verifying the signature to determine whether it is the manufacturer's signature.

20. A method as claimed in claim 19, wherein the manufacturer certificate is signed using the manufacturer's private key such that on connection to the network a public key certificate is obtained with which to verify the signature.

21. A method as claimed in claim 19, wherein the verification of the signature is carried out by the issuer.

22. A method as claimed in claim 19, wherein following successful verification of a signature, a further public key certificate is made available to support transactions with the terminal, the public key having been stored in the manufacturer certificate.

23. A module as claimed in claim 2, further including a certification authority certificate.

24. A module as claimed in claim 2, wherein the at least one certificate is stored externally of said module at a remote location which is derivable from an address stored on said module.

25. A module as claimed in claim 3, wherein the at least one certificate is stored externally of said module at a remote location which is derivable from an address stored on said module.

26. A module as claimed in claim 2, wherein the further private key is the manufacturer's private key.

27. A module as claimed in claim 3, wherein the further private key is the manufacturer's private key.

28. A module as claimed in claim 4, wherein the further private key is the manufacturer's private key.

29. A module as claimed in claim 2, wherein the further private key is an initial management key, the module further having stored thereon an initial management certificate signed using the manufacturer's private key.

30. A module as claimed in claim 3, wherein the further private key is an initial management key, the module further having stored thereon an initial management certificate signed using the manufacturer's private key.

31. A module as claimed in claim 4, wherein the further private key is an initial management key, the module further having stored thereon an initial management certificate signed using the manufacturer's private key.

32. A method according to claim 8, wherein the manufacturer certificate is created externally of the module.

33. A method as claimed in claim 8, wherein the further private key is the manufacturer's private key.

34. A method as claimed in claim 9, wherein the further private key is the manufacturer's private key.

35. A method as claimed in claim 10, wherein the further private key is the manufacturer's private key.

36. A method as claimed in claim 11, wherein the further private key is the manufacturer's private key.

37. A method as claimed in claim 20, wherein the verification of the signature is carried out by the issuer.

38. A method as claimed in claim 20, wherein following successful verification of a signature, a further public key certificate is made available to support transactions with the terminal, the public key having been stored in the manufacturer certificate.

39. A method as claimed in claim 21, wherein following successful verification of a signature, a further public key certificate is made available to support transactions with the terminal, the public key having been stored in the manufacturer certificate.
